(19) United States
(12) Patent Application Publication
(10) Pub. No.: US 2017/0131380 A1
(43) Pub. Date: May 11, 2017

(54) TRANSMITTER CAPABILITIES FOR ANGLE OF DEPARTURE

(71) Applicant: QUALCOMM Incorporated, San Diego, CA (US)

(72) Inventors: Rahul Malik, San Diego, CA (US); Carlos Horacio Aldana, Mountain View, CA (US)

(21) Appl. No.: 15/346,406

(22) Filed: Nov. 8, 2016

Related U.S. Application Data
(60) Provisional application No. 62/253,012, filed on Nov. 9, 2015.
(60) Provisional application No. 62/278,850, filed on Jan. 14, 2016.

(51) Int. Cl. G01S 3/48; G01S 3/02; H04L 29/06

(52) U.S. Cl. CPC G01S 3/48; H04L 69/22; G01S 3/023; H04W 84/12

(57) ABSTRACT

Aspects of the present disclosure may compensate for a presence of phase ambiguity between transmit chains of a transmitting device when estimating angle of departure information of a wireless signal transmitted from the transmitting device. In some aspects, a receiving device may determine phase information of the wireless signal, and then determine whether there is a presence or absence of phase ambiguity between a number of transmit chains of the transmitting device. If there is presence of phase ambiguity in the transmitting device, then the receiving device may adjust the phase information of the received wireless signal. If there is an absence of phase ambiguity in the transmitting device, then the receiving device may not adjust the phase information. Thereafter, the receiving device may estimate the angle of departure of the wireless signal based on the selectively adjusted phase information.

### CROSS-REFERENCE TO RELATED APPLICATIONS

This application claims priority under 35 USC 119(e) to co-pending and commonly owned U.S. Provisional Patent Application No. 62/253,012 entitled “TRANSMITTER CAPABILITIES FOR ANGLE OF DEPARTURE” filed on Nov. 9, 2015 and to co-pending and commonly owned U.S. Provisional Patent Application No. 62/278,850 entitled “TRANSMITTER CAPABILITIES FOR ANGLE OF DEPARTURE” filed on Jan. 14, 2016, the entireties of both of which are incorporated by reference herein.

### TECHNICAL FIELD

Aspects of the present disclosure relate generally to wireless networks, and specifically to estimating the angle of departure of signals transmitted in wireless networks.

### BACKGROUND

Angle of arrival (AoA) and angle of departure (AoD) information of wireless signals transmitted between devices may be estimated and thereafter used to determine the relative position and orientation between the devices. For example, signals may be received by a first device from a second device, and the first device may use AoA and/or AoD information of the received signals to determine a line of bearing with respect to the second device. If the location and orientation of the second device is known, then the first device may determine its position and orientation relative to the second device.

Because estimating AoA and AoD information is a passive positioning operation (e.g., the first device does not need to transmit any signals to the second device), the first device may consume less power and bandwidth compared to devices that perform active positioning operations (e.g., such as active ranging operations using fine-timing measurement (FTM) frames). In addition, because passive positioning operations based on estimating AoA and AoD information may be performed without capturing time of arrival (TOA) or time of departure (TOD) information, the accuracy of passive positioning operations is not dependent upon timing synchronization between the devices or processing delays associated with the devices.

Because positioning operations are becoming increasing important for device location and tracking in wireless networks, it would be desirable to improve the accuracy of estimated AoA and AoD information without sacrificing performance.

### SUMMARY

This Summary is provided to introduce in a simplified form a selection of concepts that are further described below in the Detailed Description. This summary is not intended to identify key features or essential features of the claimed subject matter, nor is it intended to limit the scope of the claimed subject matter.

Apparatuses and methods for estimating angle of departure information are disclosed herein. In one aspect, a method is disclosed. The method may be performed by a receiving device, and may include receiving a wireless signal from a transmitting device; determining phase information of the wireless signal; determining a presence or absence of phase ambiguity between a number of transmit chains of the transmitting device; selectively adjusting the phase information based on the presence or absence of phase ambiguity between the number of transmit chains of the transmitting device; and estimating an angle of departure of the wireless signal from the transmitting device based on the selectively adjusted phase information.

In another aspect, a receiving device is disclosed. The receiving device may include one or more processors and a memory. The memory may include instructions that, when executed by the one or more processors, cause the receiving device to receive a wireless signal from a transmitting device; determine phase information of the wireless signal; determine a presence or absence of phase ambiguity between a number of transmit chains of the transmitting device; selectively adjust the phase information based on the presence or absence of phase ambiguity between the number of transmit chains of the transmitting device; and estimate an angle of departure of the wireless signal from the transmitting device based on the selectively adjusted phase information.

In another aspect, a non-transitory computer-readable medium is disclosed. The non-transitory computer-readable medium may comprise instructions that, when executed by a receiving device, cause the receiving device to perform a number of operations. The number of operations may include receiving a wireless signal from a transmitting device; determining phase information of the wireless signal; determining a presence or absence of phase ambiguity between a number of transmit chains of the transmitting device; selectively adjusting the phase information based on the presence or absence of phase ambiguity between the number of transmit chains of the transmitting device; and estimating an angle of departure of the wireless signal from the transmitting device based on the selectively adjusted phase information.

In another aspect, a receiving device is disclosed. The receiving device may include means for receiving a wireless signal from a transmitting device; means for determining phase information of the wireless signal; means for determining a presence or absence of phase ambiguity between a number of transmit chains of the transmitting device; means for selectively adjusting the phase information based on the presence or absence of phase ambiguity between the number of transmit chains of the transmitting device; and means for estimating an angle of departure of the wireless signal from the transmitting device based on the selectively adjusted phase information.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless system within which aspects of the present disclosure may be implemented.

FIG. 2 shows a block diagram of a wireless device in accordance with aspects of the present disclosure.

FIG. 3A shows an example reception of a wireless signal by two antennas of a receiving device.

FIG. 3B shows an example transmission of a wireless signal from two antennas of a transmitting device to a single antenna of a receiving device.

FIG. 4A shows an example packet within which aspects of the present disclosure may be implemented.

FIG. 4B shows an example packet within which aspects of the present disclosure may be implemented.

FIG. 5A shows an example frame within which aspects of the present disclosure may be implemented.

FIG. 5B shows a very high throughput (VHT) preamble within which aspects of the present disclosure may be implemented.

FIG. 5C shows a high efficiency (HE) preamble within which aspects of the present disclosure may be implemented.

FIG. 6A shows an illustrative flow chart depicting an example operation for estimating angle of departure information according to aspects of the present disclosure.

FIG. 6B shows an illustrative flow chart depicting an example operation for determining the presence of phase ambiguity between transmit chains of a transmitting device.

FIG. 6C shows an illustrative flow chart depicting an example operation for determining the absence of phase ambiguity between transmit chains of a transmitting device.

FIG. 6D shows an illustrative flow chart depicting an example operation for adjusting phase information of a received wireless signal.

FIG. 7 shows an illustrative flow chart depicting another example operation for estimating angle of departure information according to aspects of the present disclosure.

FIG. 8 shows an illustrative flow chart depicting another example operation for estimating angle of departure information according to aspects of the present disclosure.

### DETAILED DESCRIPTION

Aspects of the present disclosure are described below in the context of estimating angle of arrival (AoA) and angle of departure (AoD) information for devices deployed in a wireless local area network (WLAN) for simplicity only. It is to be understood that aspects of the present disclosure are equally applicable to estimating AoA and/or AoD information for devices deployed in other wireless networks (e.g., cellular networks, personal area networks, pico networks, femto networks, and satellite networks). As used herein, the terms “WLAN” and “Wi-Fi®” may include communications governed by the IEEE 802.11 family of standards, Bluetooth, HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including an AP and a plurality of STAs, aspects of the present disclosure are equally applicable to other WLAN systems including, for example, WLANs including a plurality of APs, peer-to-peer (or Independent Basic Service Set) systems, Wi-Fi Direct systems, and/or Hotspots. Further, although described herein in terms of exchanging data packets between wireless devices, aspects of the present disclosure may be applied to the exchange of any data unit, packet, and/or frame between wireless devices. Thus, the term “data packet” may include any frame, packet, or data unit such as, for example, protocol data units (PDUs), MAC protocol data units (MPDUs), and physical layer convergence procedure protocol data units (PPDUs). The term “A-MPDU” may refer to aggregated MPDUs. The PDUs and/or PPDUs may include a physical-layer (PHY) service data unit (PSDU), which in turn may contain encapsulated data such as, for example, a MAC service data unit (MSDU) or a MAC frame.

Further, as used herein, the term “HT” may refer to a high throughput frame format or protocol defined, for example, by the IEEE 802.11n standards; the term “VHT” may refer to a very high throughput frame format or protocol defined, for example, by the IEEE 802.11ac standards; the term “HE” may refer to a high efficiency frame format or protocol defined, for example, by the IEEE 802.11ax standards; and the term “non-HT” may refer to a legacy frame format or protocol defined, for example, by the IEEE 802.11a/g standards. Thus, the terms “legacy” and “non-HT” may be used interchangeably herein. In addition, the term “legacy device” as used herein may refer to a device that operates according to the IEEE 802.11a/g standards, and the term “HE device” as used herein may refer to a device that operates according to the IEEE 802.11ax and/or 802.11az standards.

In the following description, numerous specific details are set forth such as examples of specific components, circuits, and processes to provide a thorough understanding of the present disclosure. The term “coupled” as used herein means connected directly to or connected through one or more intervening components or circuits. The term “angle information” as used herein may refer to AoA information and/or AoD information. Also, in the following description and for purposes of explanation, specific nomenclature is set forth to provide a thorough understanding of the present disclosure. However, it will be apparent to one skilled in the art that these specific details may not be required to practice the example implementations. In other instances, well-known circuits and devices are shown in block diagram form to avoid obscuring the present disclosure. The present disclosure is not to be construed as limited to specific examples described herein but rather to include within their scopes all implementations defined by the appended claims.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Also, “determining” may include measuring, estimating, and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any such list including multiples of the same members (e.g., any lists that include aa, bb, or cc).

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims. Also, the example wireless communications devices may include components other than those shown.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

As mentioned above, a receiving device may use AoA and/or AoD information of signals received from a transmitting device to determine its position and/or orientation relative to the transmitting device. Recent revisions to the IEEE 802.11 family of standards provide mechanisms for a transmitting device to provide its location and orientation to a number of receiving devices. This information may assist the receiving devices to determine their positions based on AoA information and/or AoD information of signals received from the transmitting device. Phase ambiguity may exist between a number of transmit chains of the transmitting device and/or between a number of antennas of the transmitting device. For example, a transmitting device may have a packet-to-packet phase ambiguity for one or more of its transmit chains due to a lack of clock synchronization between its respective transmit chains. The presence of phase ambiguity in the transmitting device may degrade the receiving device's ability to accurately estimate AoD information of signals transmitted from the transmitting device. In similar manner, receiving devices may have a packet-to-packet phase ambiguity due to a lack of clock synchronization between its receive chains. The presence of phase ambiguity in the receiving device may degrade the receiving device's ability to accurately estimate AoA information of signals received from the transmitting device. These are at least some of the technical problems to be solved by various aspects of the present disclosure.

The apparatuses and methods disclosed herein may improve the accuracy with which a receiving device may estimate AoD information of signals transmitted from a transmitting device by allowing the transmitting device to indicate the presence of phase ambiguity between a number of transmit chains (or between a number of antennas) of the transmitting device. An indication of the presence of phase ambiguity between the transmit chains of the transmitting device may hereinafter be referred to as a phase ambiguity indicator. For some implementations, the transmitting device may embed or otherwise include the phase ambiguity indicator in a wireless signal transmitted to the receiving device, and the receiving device may extract the phase ambiguity indicator from the wireless signal to determine a presence of phase ambiguity between transmit chains of the transmitting device.

If there is a presence of phase ambiguity in the transmitting device, the transmitting device may indicate, to the receiving device, one or more phase ambiguity values indicative of phase shifts between the transmit chains of the transmitting device. As used herein, phase shifts between transmit chains may also be referred to as phase offsets or phase differences between the transmit chains. For some implementations, the transmitting device may embed or otherwise include the one or more phase ambiguity values in a wireless signal transmitted to the receiving device, and the receiving device may extract the one or more phase ambiguity values from the wireless signal to compensate for the presence of phase ambiguity in the transmitting device. In some aspects, the phase ambiguity indicator and the one or more phase ambiguity values may be embedded or otherwise included in the same wireless signal. In other aspects, the phase ambiguity indicator and the one or more phase ambiguity values may be embedded or otherwise included in different wireless signals.

The receiving device may use the phase ambiguity indicator to determine whether phase information determined for signals received from the transmitting device should be adjusted, for example, due to the presence of phase ambiguity in the transmitting device. In some aspects, the receiving device may use the one or more phase ambiguity values to adjust the determined phase information, for example, to generate adjusted phase information that compensates for phase shifts between transmit chains of the transmitting device. The receiving device may then estimate AoD information for signals transmitted from the transmitting device based on the adjusted phase information. These and other details of the present disclosure, which provide one or more solutions to the aforementioned technical problems, are discussed in detail below.

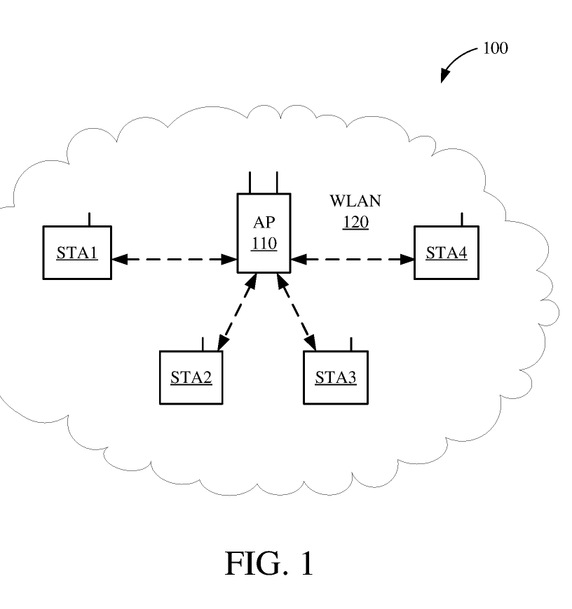

FIG. 1 shows a block diagram of an example wireless system 100 within which aspects of the present disclosure may be implemented. The wireless system 100 is shown to include four wireless stations STA1-STA4, a wireless access point (AP) 110, and a wireless local area network (WLAN) 120. The WLAN 120 may be formed by a plurality of access points (APs) that may operate according to the IEEE 802.11 family of standards (or according to other suitable wireless protocols). Thus, although only one AP 110 is shown in FIG. 1 for simplicity, it is to be understood that WLAN 120 may be formed by any number of access points such as AP 110. The AP 110 may be assigned a unique MAC address that is programmed therein by, for example, the manufacturer of the access point. Similarly, each of stations STA1-STA4 may also be assigned a unique MAC address. Although not specifically shown in FIG. 1, for at least some implementations, the stations STA1-STA4 may exchange signals directly with each other (e.g., without the presence of AP 110).

For some implementations, the wireless system 100 may correspond to a multiple-input multiple-output (MIMO) wireless network, and may support single-user MIMO (SU-MIMO) and multi-user (MU-MIMO) communications. Further, although the WLAN 120 is depicted in FIG. 1 as an infrastructure Basic Service Set (BSS), for other implementations, WLAN 120 may be an Independent Basic Service Set (IBSS), an Extended Basic Service Set, an ad-hoc network, or a peer-to-peer (P2P) network (e.g., operating according to the Wi-Fi Direct protocols).

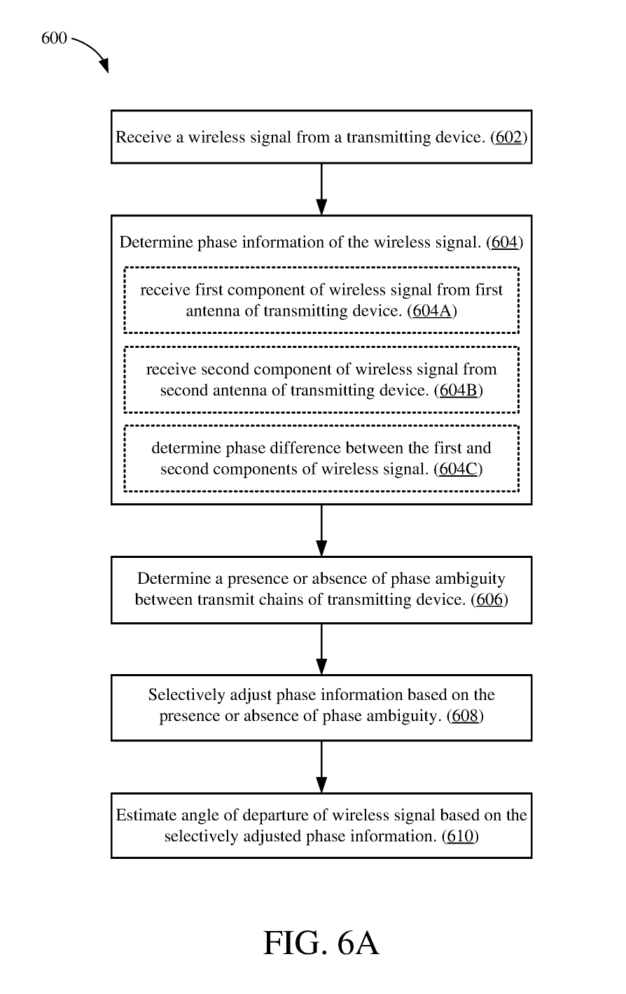

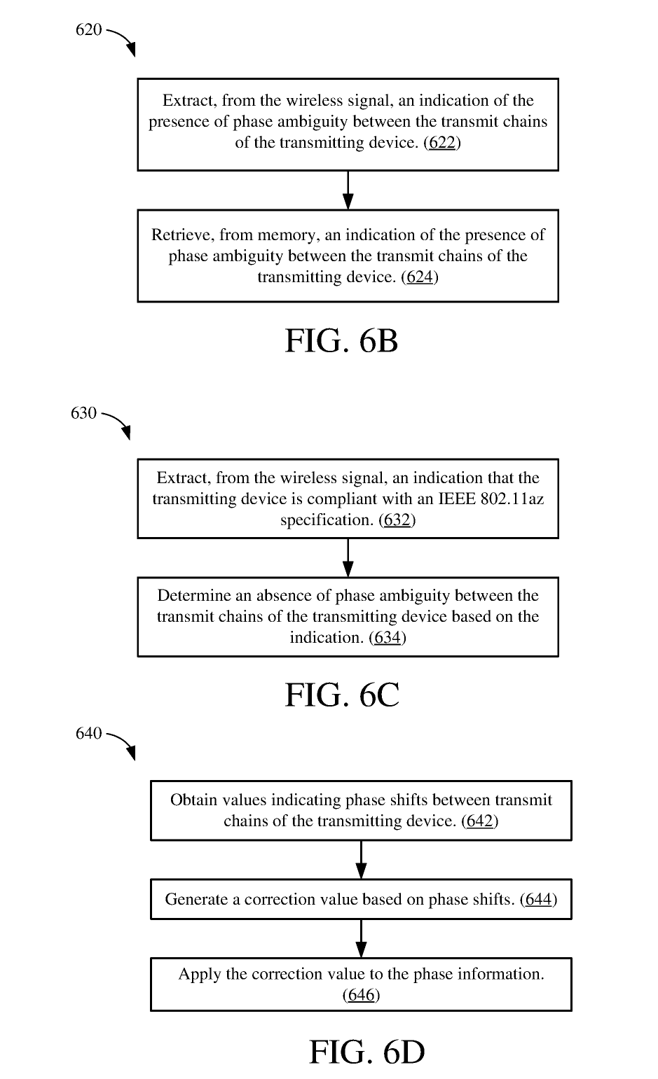

The stations STA1-STA4 may be any suitable Wi-Fi enabled wireless devices including, for example, cell phones, personal digital assistants (PDAs), tablet devices, laptop computers, or the like. The stations STA1-STA4 may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some implementations, each of stations STA1-STA4 may include a transceiver, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 6A-6D, 7, and 8.

The AP 110 may be any suitable device that allows one or more wireless devices to connect to a network (e.g., a local area network (LAN), wide area network (WAN), metropolitan area network (MAN), and/or the Internet) via AP 110 using Wi-Fi, Bluetooth, cellular, or any other suitable wireless communication standards. For at least some implementations, AP 110 may include a transceiver, a network interface, one or more processing resources, and one or more memory sources. The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 6A-6D, 7, and 8. For other implementations, one or more functions of AP 110 may be performed by one of stations STA1-STA4 (e.g., operating as a soft AP).

For the stations STA1-STA4 and/or AP 110, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct frequency bands and/or using distinct communication protocols. For example, the Wi-Fi transceiver may communicate within a 2.4 GHz frequency band, within a 5 GHz frequency band, and/or within a 60 GHz frequency band in accordance with the IEEE 802.11 family of standards. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). For other implementations, the transceivers included within the stations STA1-STA4 and/or the AP 110 may be any technically feasible transceiver such as a ZigBee transceiver described by a specification from the ZigBee specification, a WiGig transceiver, and/or a HomePlug transceiver described by a specification from the HomePlug Alliance.

The AP 110 may periodically broadcast beacon frames to enable any STAs within wireless range of the AP 110 to establish and/or maintain a communication link with the wireless network 100. The beacon frames, which may include a traffic indication map (TIM) indicating whether the AP 110 has queued downlink data for the stations STA1-STA4, are typically broadcast according to a target beacon transmission time (TBTT) schedule. The broadcasted beacon frames may also include the AP's timing synchronization function (TSF) value. The stations STA1-STA4 may synchronize their own local TSF values with the broadcasted TSF value, for example, so that all the stations STA1-STA4 are synchronized with each other and the AP 110.

For at least some implementations, each of the stations STA1-STA4 and AP 110 may include RF ranging circuitry (e.g., formed using well-known software modules, hardware components, and/or a suitable combination thereof) that may be used to estimate the distance between itself and another Wi-Fi enabled device using any suitable ranging operation. In addition, each of the stations STA1-STA4 and/or AP 110 may include a local memory (not shown in FIG. 1 for simplicity) to store a cache of Wi-Fi access point and/or station data.

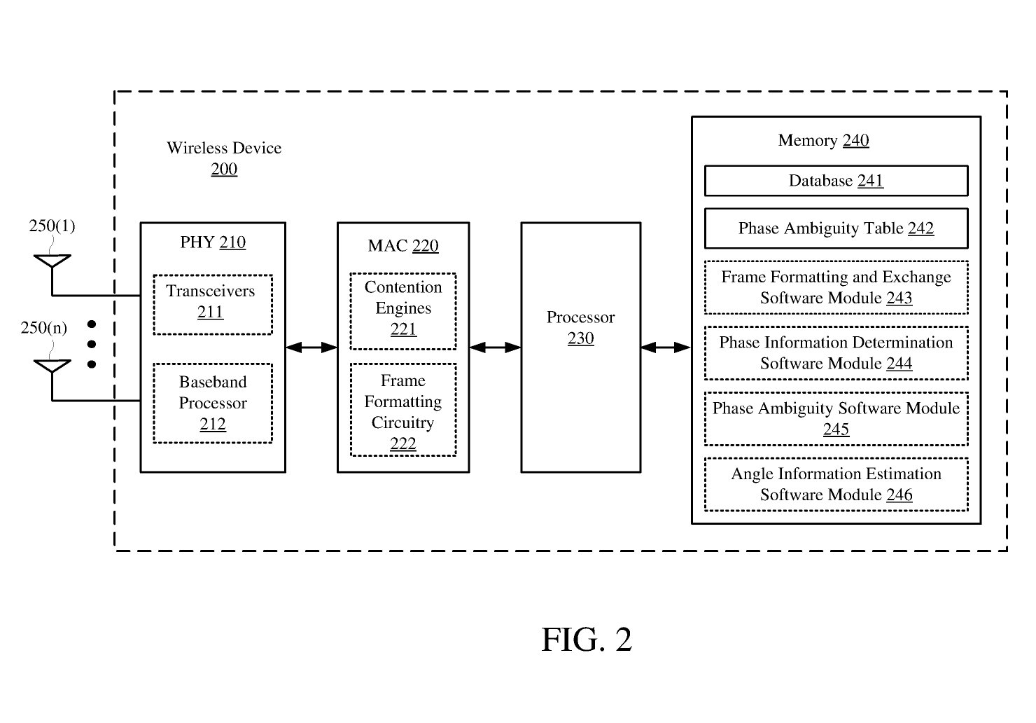

FIG. 2 shows a wireless device 200 that may be one implementation of at least one of the stations STA1-STA4 or the AP 110 of FIG. 1. The wireless device 200 may include a physical-layer device (PHY) 210, may include a medium access controller (MAC) 220, may include a processor 230, may include a memory 240, and may include a number of antennas 250(1)-250(n). The PHY 210 may include at least a number of transceivers 211 and a baseband processor 212. The transceivers 211 may be coupled to antennas 250(1)-250(n), either directly or through an antenna selection circuit (not shown for simplicity). The transceivers 211 may be used to transmit signals to and receive signals other wireless devices including, for example, AP 110 and/or one or more of stations STA1-STA4 of FIG. 1. Although not shown in FIG. 2 for simplicity, the transceivers 211 may include any number of transmit chains to process and transmit signals to other wireless devices via antennas 250(1)-250(n), and may include any number of receive chains to process signals received from antennas 250(1)-250(n). Thus, the wireless device 200 may be configured for MIMO operations. The MIMO operations may include SU-MIMO operations and/or MU-MIMO operations. Further, in some aspects, the wireless device 200 may use multiple antennas 250(1)-250(n) to provide antenna diversity. Antenna diversity may include polarization diversity, pattern diversity, and/or spatial diversity.

The baseband processor 212 may be used to process signals received from processor 230 and/or memory 240 and to forward the processed signals to transceivers 211 for transmission via one or more of antennas 250(1)-250(n), and may be used to process signals received from one or more of antennas 250(1)-250(n) via transceivers 211 and to forward the processed signals to processor 230 and/or memory 240.

The MAC 220 may include at least a number of contention engines 221 and frame formatting circuitry 222. The contention engines 221 may contend for access to one or more shared wireless mediums, and may also store packets for transmission over the one or more shared wireless mediums. For other implementations, the contention engines 221 may be separate from MAC 220. For still other implementations, the contention engines 221 may be implemented as one or more software modules (e.g., stored in memory 240 or stored in memory provided within MAC 220) containing instructions that, when executed by processor 230, perform the functions of contention engines 221.

The frame formatting circuitry 222 may be used to create and/or format frames received from processor 230 and/or memory 240 (e.g., by adding MAC headers to PDUs provided by processor 230), and may be used to re-format frames received from PHY 210 (e.g., by stripping MAC headers from frames received from PHY 210). In some aspects, the frame formatting circuitry 222 may be used to embed a phase ambiguity indicator within packets or signals to be transmitted from wireless device 200, and/or to embed one or more phase ambiguity values within packets or signals to be transmitted from wireless device 200. In some aspects, each of the one or more phase ambiguity values may indicate a phase shift between a corresponding pair of transmit chains of wireless device 200. In other aspects, each of the one or more phase ambiguity values may indicate a phase shift between a corresponding pair of antennas 250(1)-250(n) of wireless device 200.

Memory 240 may include a database 241 that may store location data, configuration information, data rates, MAC addresses, and other suitable information about (or pertaining to) a number of access points, stations, and/or other wireless devices. The database 241 may also store profile information for a number of wireless devices. The profile information for a given wireless device may include, for example, the wireless device's service set identification (SSID), channel information, received signal strength indicator (RSSI) values, goodput values, channel state information (CSI), and connection history with wireless device 200.

Memory 240 may include a phase ambiguity table 242 that may store phase ambiguity information for one or more other devices. The phase ambiguity information may include phase ambiguity indicators and/or phase ambiguity values for each of the one or more other devices. In some aspects, the phase ambiguity information for a given device may be stored in the phase ambiguity table 242 upon reception of signals transmitted from the given device and/or in response to prior signal exchanges between wireless device 200 and the given device. In other aspects, the phase ambiguity information for a given device may be obtained from or shared by another device (e.g., a device that previously obtained phase ambiguity information of the given device).

Memory 240 may also include a non-transitory computer-readable storage medium (e.g., one or more nonvolatile memory elements, such as EPROM, EEPROM, Flash memory, a hard drive, and so on) that may store the following software modules:
a frame formation and exchange software module 243 to facilitate the creation and exchange of frames (e.g., data frames, control frames, management frames, and action frames), for example, as described below with respect to FIGS. 6A-6D, 7, and 8;
a phase information determination software module 244 to facilitate the determination of phase information of wireless signals received from other devices and/or to adjust determined phase information based on one or more phase ambiguity values, for example, as described below with respect to FIGS. 6A-6D, 7, and 8;
a phase ambiguity software module 245 to facilitate the detection of phase ambiguity indicators and/or phase ambiguity values embedded in received wireless signals, for example, as described below with respect to FIGS. 6A-6D, 7, and 8; and
an angle information estimation software module 246 to estimate AoA and/or AoD information of received wireless signals based, at least in part, on phase information provided by the phase information determination software module 244, phase ambiguity indicators, and/or one or more phase ambiguity values, for example, as described below with respect to FIGS. 6A-6D, 7, and 8.

Each software module includes instructions that, when executed by processor 230, may cause wireless device 200 to perform the corresponding functions. The non-transitory computer-readable medium of memory 240 thus includes instructions for performing all or a portion of the operations described below with respect to FIGS. 6A-6D, 7, and 8.

Processor 230 may be any one or more suitable processors capable of executing scripts or instructions of one or more software programs stored in wireless device 200 (e.g., within memory 240). For example, processor 230 may execute the frame formation and exchange software module 243 to facilitate the creation and exchange of frames (e.g., data frames, control frames, management frames, and action frames). Processor 230 may execute the phase information determination software module 244 to facilitate the determination of phase information of wireless signals received from other devices and/or to adjust determined phase information based on one or more phase ambiguity values. In some aspects, processor 230 may execute the phase ambiguity software module 245 to facilitate the detection of phase ambiguity indicators and/or phase ambiguity values embedded in received wireless signals. In other aspects, processor 230 may execute the phase ambiguity software module 245 to embed phase ambiguity indicators and/or phase ambiguity values into wireless signals transmitted from wireless device 200. Processor 230 may execute the angle information estimation software module 246 to estimate AoA and/or AoD information of received wireless signals based, at least in part, on phase information provided by the phase information determination software module 244, phase ambiguity indicators, and/or one or more phase ambiguity values.

A receiving device may include any number of antennas, for example, as depicted by wireless device 200 of FIG. 2. Thus, when a wireless signal is transmitted from a transmitting device to a receiving device, the wireless signal may be received by different antennas of the receiving device at different times—and therefore with different phases—due to physical spacing between the antennas of the receiving device.

A transmitting device may also include any number of antennas, for example, as depicted by wireless device 200 of FIG. 2. Thus, when a signal is transmitted from a transmitting device to a receiving device, an antenna of the receiving device may receive a signal component from each of the transmitting device's antennas at different times—and therefore with different phases—due to physical spacing between the antennas of the transmitting device.

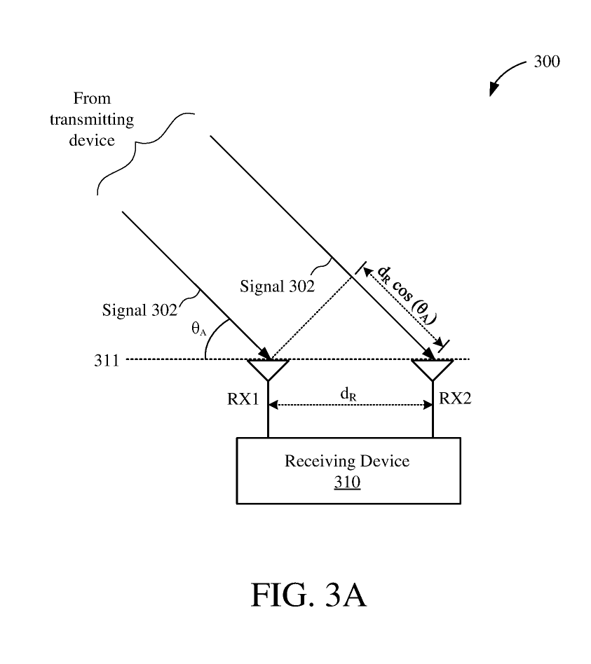

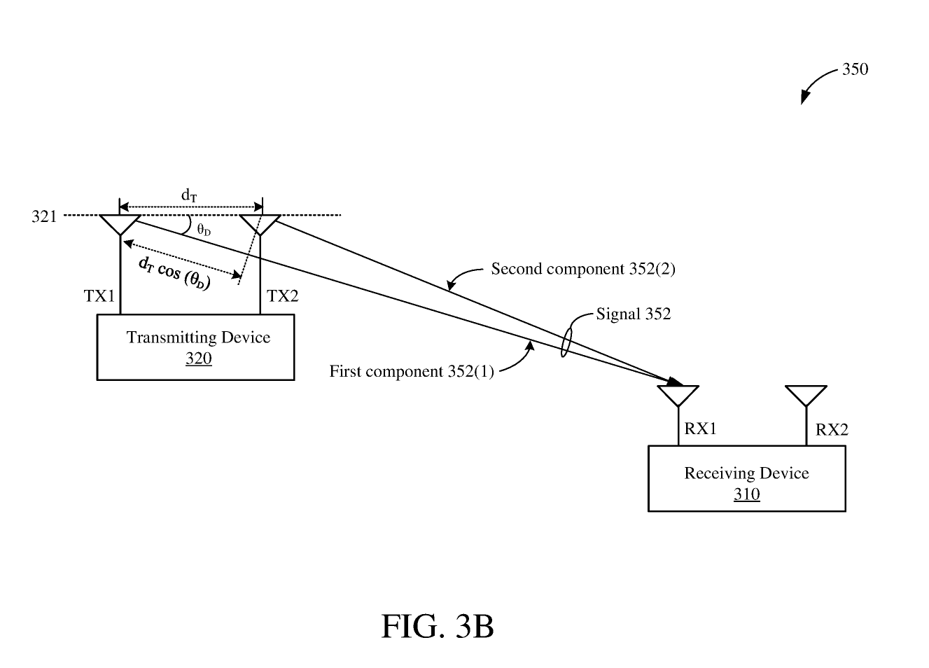

FIG. 3A is an illustration 300 depicting reception of a signal 302 by a receiving device 310 that includes two antennas RX1 and RX2 separated by a distance d_{R}. For the example of FIG. 3A, the signal 302 is received at the first antenna RX1 and the second antenna RX2 at an angle of arrival θ_{A} relative to an axis line 311 extending between the first and second antennas RX1 and RX2. Because the first and second antennas RX1 and RX2 are separated by a distance d_{R}, the signal 302 as received by the second antenna RX2 travels a distance approximately equal to d cos θ_{A} longer than the signal 302 as received by the first antenna RX1. The phase difference observed between the first and second antennas RX1 and RX2 may be expressed as:

$$Δ Phase = \frac{2 π {d}_{R} cos {θ}_{A}}{λ}$$

where λ is the wavelength of signal 302. Assuming d≈λ/2, the phase difference may be expressed as:

ΔPhase=π cos θ_{A}

In some aspects, the phase difference between the signal 302 as received by the first antenna RX1 and the signal 302 as received by the second antenna RX2 may be referred to as the phase information of the signal 302. Thereafter, the receiving device 310 may estimate the angle of arrival θ_{A} of the signal 302 received from the transmitting device based on the determined phase information (or phase difference) using any suitable well-known techniques.

FIG. 3B is an illustration 350 depicting transmission of a wireless signal 352 from a transmitting device 320 to the receiving device 310. The transmitting device 320 is shown to include first and second antennas TX1 and TX2 separated by a distance d_{T}. For the example of FIG. 3B, the wireless signal 352 is transmitted from the first and second antennas TX1 and TX2 of the transmitting device 330 at a departure angle θ_{D} relative to an axis line 321 extending between the first and second antennas TX1 and TX2, and is received by the first antenna RX1 of the receiving device 310. Because the first and second antennas TX1 and TX2 are separated by a distance d_{T}, a first component 352(1) of the signal 352 transmitted by the first antenna TX1 travels a distance equal to d_{T} cos θ_{D} longer than a second component 352(2) of the signal 352 transmitted by the second antenna TX2. The phase difference between the first component 352(1) and the second component 352(2), as observed at the first antenna RX1 of the receiving device 310, may be expressed as:

$$Δ Phase = \frac{2 π {d}_{T} cos {θ}_{D}}{λ}$$

where λ is the wavelength of signal 352. Assuming d≈λ/2, the phase difference may be expressed as:

ΔPhase=π cos θ_{D}

In some aspects, the phase difference between the first component 352(1) and the second component 352(2) may be referred to as the phase information of the signal 352. Thereafter, the receiving device 340 may estimate the angle of departure θ_{D} of the signal 352 from the transmitting device 330 based on the determined phase information or phase difference (ΔPhase) using any suitable well-known techniques.

It is noted that multipath signal propagation (e.g., multipath effects) may degrade the accuracy with which the receiving device 310 may estimate AoA and AoD information. One or more suitable techniques including, for example, ESPRIT (Estimation of Signal Parameters via Rotational Invariance Techniques) and MUSIC (MUltiple SIgnal Classification) or Bartlett or Capon methods may be used for estimating AoA and AoD information in the presence of multipath effects.

As discussed above, the presence of phase ambiguity between transmit chains of a transmitting device may degrade the accuracy with which a receiving device may estimate AoD information. Phase ambiguity may be less problematic for estimating AoA information, for example, because a receiving device may determine the phase ambiguity between its own receive chains, and then compensate for its “local” phase ambiguity prior to estimating AoA information.

As mentioned above, aspects of the present disclosure may improve the accuracy with which a receiving device may estimate AoD information of wireless signals transmitted from a transmitting device by allowing the transmitting device to embed a phase ambiguity indicator and/or one or more phase ambiguity values into the wireless signals. It is noted that if there is not any (or a negligible amount of) phase ambiguity between the transmit chains of the transmitting device, then the receiving device may not need to adjust phase information determined from the received wireless signals. Thus, if there is not a presence of phase ambiguity in a transmitting device, the transmitting device may embed, into transmitted wireless signals, a phase ambiguity indicator that indicates a lack of phase ambiguity in the transmitting device. In this manner, a receiving device may extract the phase ambiguity indicator from wireless signals transmitted from the transmitting device, and determine that AoD information may be estimated without compensating for phase ambiguity in the transmitting device.

For some implementations, the phase ambiguity indicator may be a static signal indicating that the transmitting device is subject to phase ambiguity. The receiving device may receive this indication and avoid computing angle information of wireless signals received from the transmitting device, for example, due to potential errors in angle information estimation resulting from phase ambiguity between the transmit chains of the transmitting device.

Conversely, if there is a presence of phase ambiguity between the transmit chains of a transmitting device, then the transmitting device may set the phase ambiguity indicator to a state that indicates the presence of phase ambiguity and also provide (e.g., within the transmitted wireless signals) one or more phase ambiguity values indicative of the phase shifts between the transmit chains of the transmitting device. In this manner, the receiving device may generate a correction value based on the one or more phase ambiguity values, and then apply the correction value to the determined phase information to generate adjusted phase information (e.g., thereby compensating for the phase ambiguity in the transmitting device). Thereafter, the receiving device may estimate AoD information of the wireless signals based on the adjusted phase information, for example, instead of the originally determined phase information).

For some implementations, the phase ambiguity indicator may indicate a change in the phase relationship between the transmit chains of the transmitting device based on an event that affects the relative timing between the transmit chains. For example, one event that can change the phase relationship between the transmit chains is a reset, a timing offset, or other change in the phase-locked loops (PLLs) associated with the transmit chains. In some aspects, the phase ambiguity indicator may indicate the occurrence of such an event and a specified time at which the event occurred. The receiving device may use the occurrence of the event at the specified time, as indicated by the phase ambiguity indicator, to process packets received prior to the specified time differently than packets received at or after the specified time. For example, the receiving device may apply a first correction value to the determined phase information for packets received prior to the specified time, and may apply a second correction value to the determined phase information for packets received at or after the specified time. The first correction value may be based on the phase relationship between the transmit chains prior to the specified time, and the second correction value may be based on the phase relationship between the transmit chains at or after the specified time.

A transmitting device may communicate the phase ambiguity indicator and phase ambiguity values (if any) to a number of receiving devices in any suitable manner More specifically, the phase ambiguity indicator and/or the phase ambiguity values may be embedded (or otherwise included) within any suitable portion of packets or frames associated with wireless signals transmitted to receiving devices. For some implementations, the phase ambiguity indicator and/or the phase ambiguity values may be inserted within a preamble, a midamble, and/or a postamble of packets formatted, for example, in accordance with the IEEE 802.11 standards. In some aspects, one or more symbols containing the phase ambiguity indicator may be transmitted using a single antenna of the transmitting device. For other implementations, the phase ambiguity indicator and/or the phase ambiguity values may be inserted within other portions of a packet including, for example, the PHY header, MAC header, a reserved field, a reserved bit within an existing field, an information element (IE), a vendor-specific information element (VSIE), and so on.

For some implementations, the phase ambiguity indicator may, in addition to indicating the presence or lack of phase ambiguity in the transmitting device, indicate whether the transmitting device is compliant with the IEEE 802.11az standards. For other implementations, the presence of a new symbol or bit in the packet may indicate that the transmitting device is compliant with the IEEE 802.11az standards. Because transmitting devices compliant with the IEEE 802.11az standards support next-generation (NG) packets for which there is no phase ambiguity between transmit chains, the receiving device may, upon determining that the transmitting device is compliant with the IEEE 802.11az standards, presume a lack of phase ambiguity in the transmitting device.

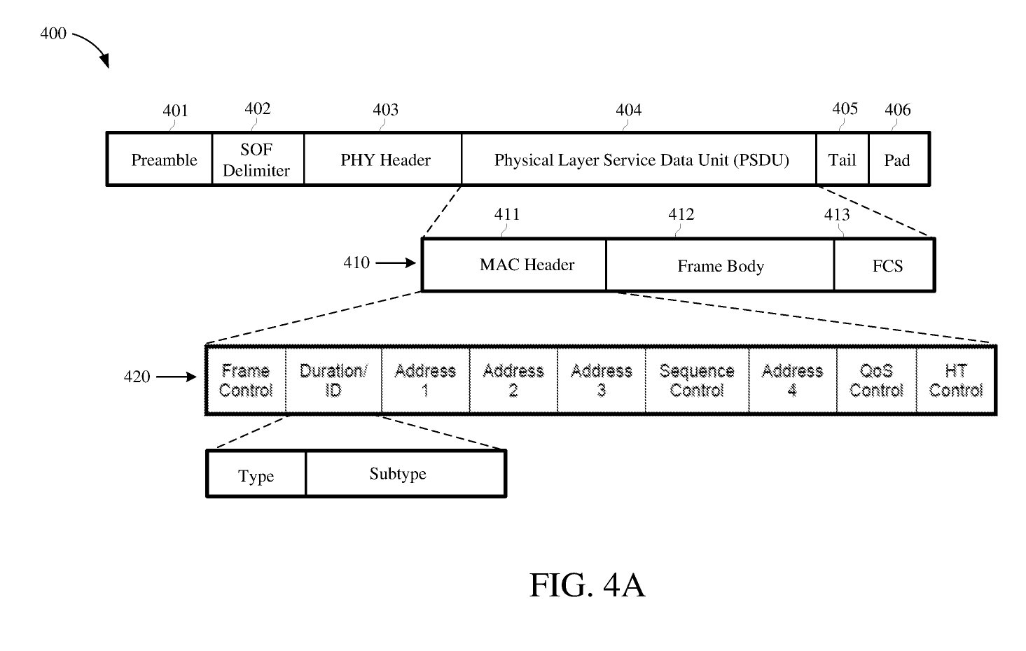

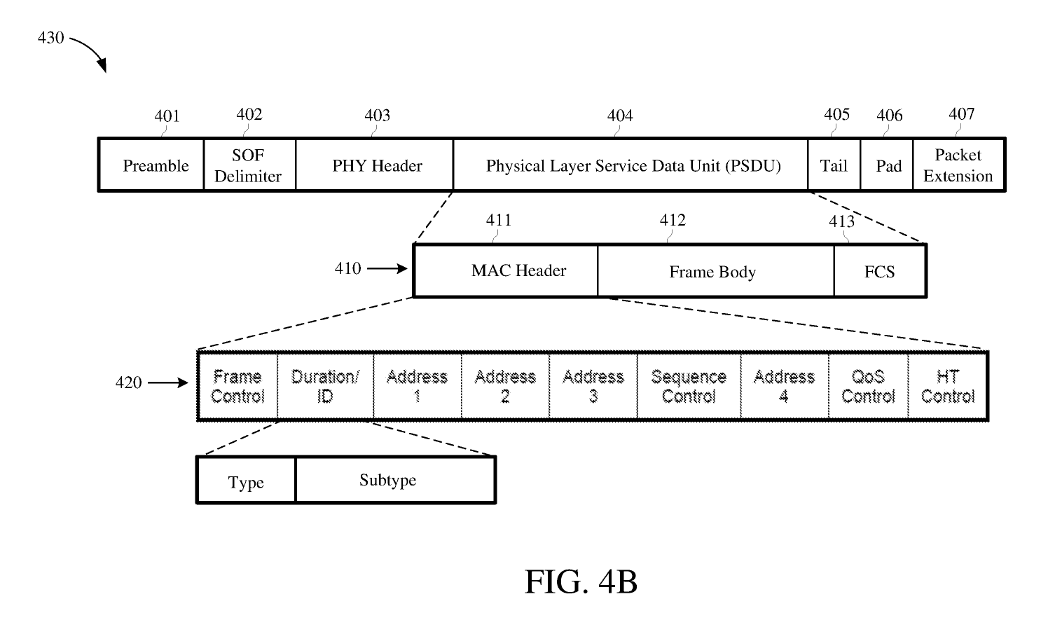

FIG. 4A shows an example packet 400 within which one or more aspects of the present disclosure may be implemented. The packet 400, which may be a VHT packet formatted in accordance with the IEEE 802.11ac standards, is shown to include a preamble 401, a start of frame (SOF) delimiter 402, a physical-layer (PHY) header 403, a Physical Layer Service Data Unit (PSDU) 404, a tail field 405, and a pad field 406. In some aspects, packet 400.

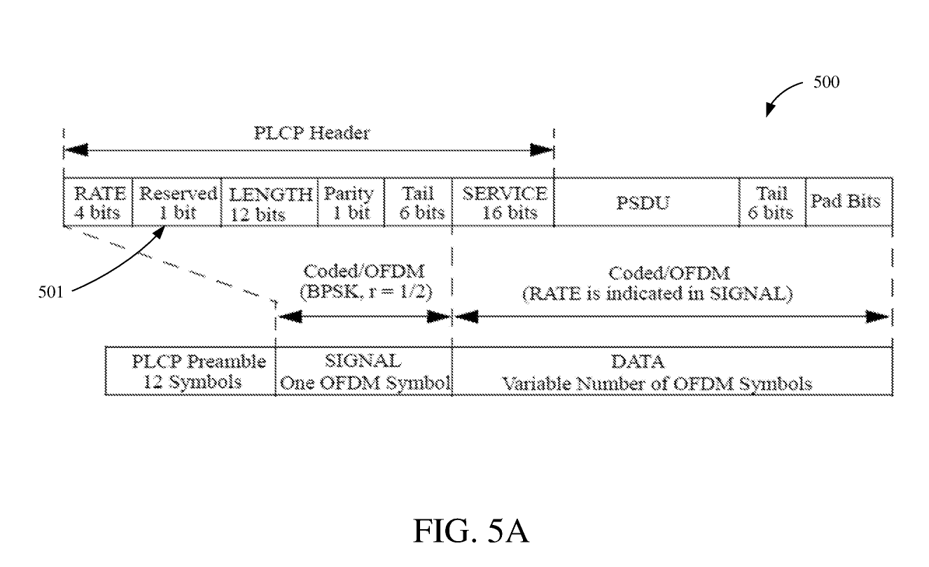

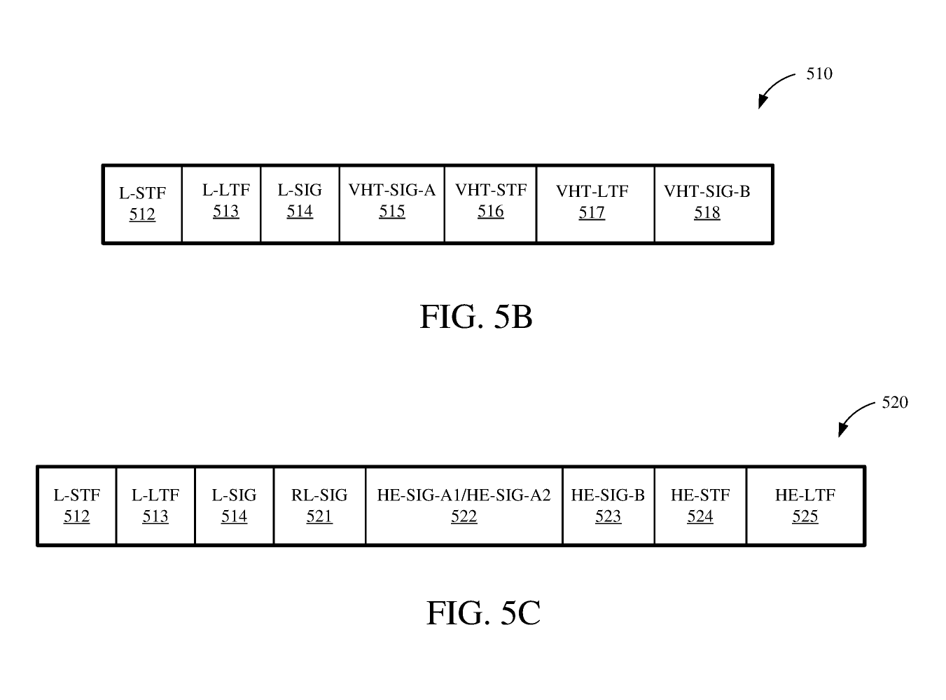

The preamble 401 may include synchronization information, timing information, frequency offset correction information, and signaling information, for example, as described in more detail below with respect to FIG. 5B. In some aspects, the preamble 401 may include a field containing a synchronization pattern (e.g., an alternating “01” pattern) that may be used to detect a potentially receivable signal, select an antenna if diversity is utilized, and determine frequency offset correction and synchronization information. The SOF delimiter 402 may indicate the start of the data frame encapsulated within the packet 400. The PHY header 403 may include a number of fields for storing data rates, a reserved bit, a length of the PSDU 404, a parity bit, a number of tail bits, and service information, as described in more detail below with respect to FIG. 5A. The PSDU 404 may contain an MPDU 410. The tail field 405 may include a number of tail bits, and the pad field 406 may include a number of pad bits.

In accordance with aspects of the present disclosure, the phase ambiguity indicator and/or the phase ambiguity values may be inserted or embedded within the preamble 401, the SOF delimiter 402, the PHY header 403, the PSDU 404, and/or the pad field 406. In some aspects, phase ambiguity indicator and the phase ambiguity values may be stored together in the same field or header of packet 400. In other aspects, the phase ambiguity indicator and the phase ambiguity values may be stored in different fields or headers of packet 400.

The MPDU 410, which may be commonly referred to as a MAC frame, may be compliant with the IEEE 802.11 family of standards. The MPDU 410 includes a MAC header 411, a frame body 412, and a frame check sequence (FCS) field 413. The MAC header 411 may include a number of fields containing information that describes characteristics or attributes of one or more packets encapsulated with the frame body 412, may include a number of fields indicating source and destination addresses of the data encapsulated in the frame body 412, and may include a number of fields containing control information. For some implementations, MAC header 411 may be used as the MAC header of any suitable data frame, control frame, management frame, and/or action frame.

More specifically, as depicted in FIG. 4A, an example MAC header 420 may include a frame control field, a duration/ID field, an address 1 field, an address 2 field, an address 3 field, a sequence control field, an address 4 field, a Quality of Service (QoS) control field, and a high-throughput (HT) field. For at least some implementations, the frame control field is 2 bytes, the duration/ID field is 2 bytes, the address 1 field is 6 bytes, the address 2 field is 6 bytes, the address 3 field is 6 bytes, the sequence control field is 2 bytes, the address 4 field is 0 or 6 bytes, the QoS control field is 0 or 2 bytes, and the HT field is 0 or 4 bytes. For other implementations, the fields of the MAC header 420 of FIG. 4A may be of other suitable lengths. The frame control field may include at least a type field and a sub-type field.

FIG. 4B shows an example packet 430 within which one or more aspects of the present disclosure may be implemented. Packet 430 is similar to the example packet 400 of FIG. 4A, except that packet 430 of FIG. 4B is shown to include a packet extension 407 appended to the end of the packet 430. In some aspects, packet 430 may be a HE packet formatted in accordance with the IEEE 802.11ax standards.

The packet extension 407 does not typically store any data. Instead, the packet extension 407 typically stores “dummy” data (e.g., repeating the last symbol of the packet payload), for example, to allow a receiving device more time to decode packet 430 without giving up medium access granted to a transmitting device. For at least some implementations, the packet extension 407 may be used to store one or more sounding sequences such as, for example, sounding LTFs. Sounding LTFs may be HE-LTFs, or may be VHT-LTFs, or any LTFs that may be used for channel sounding purposes. These one or more sounding LTFs may be used by a receiving device to estimate MIMO channel conditions, which in turn may be used by the receiving device to estimate AoD information for frames transmitted by a transmitted device.

FIG. 5A shows an example frame 500 within which aspects of the present disclosure may be implemented. The frame 500, which for at least some implementations can correspond to an OFDM frame, may be used to transport any suitable data frame, control frame, management frame, and/or action frame between wireless devices. In some aspects, the phase ambiguity indicator may be the reserved bit 501 of the Physical Layer Convergence Protocol (PLCP) header of the frame 500. In other aspects, the phase ambiguity indicator may be provided within the pad bits of frame 500.

Because the reserved bit 501 the PLCP header may be used for another purpose, it may be desirable to insert the phase ambiguity indicator into a high-throughput (HT) frame or into a very high-throughput (VHT) frame or into a High Efficiency (HE) frame.

FIG. 5B shows an example preamble 510 of a VHT packet within which aspects of the present disclosure may be implemented. The preamble 510 may be one implementation of the preamble 401 of the packet 400 of FIG. 4A and/or the preamble 401 of the packet 430 of FIG. 4B. The preamble 510, which may be compliant with the IEEE 802.11ac standards, is shown to include a Legacy Short Training Field (L-STF) 512, a Legacy Long Training Field (L-LTF) 513, a Legacy Signal (L-SIG) field 514, a very-high throughput signaling A (VHT-SIG-A) field 515, a VHT-STF field 516, a VHT-LTF field 517, and a very-high throughput signaling B (VHT-SIG-B) field 518.

The L-STF 512 may include information for coarse frequency estimation, automatic gain control, and timing recovery. The L-LTF 513 may include information for fine frequency estimation, channel estimation, and fine timing recovery. The L-SIG field 514 may include modulation and coding information. The VHT-SIG-A field 515 may include parameters such as an indicated bandwidth, a payload guard interval (GI), a coding type, a number of spatial streams (Nsts), a space-time block coding (STBC), beamforming information, and so on. Information contained in the VHT-STF 516 may be used to improve automatic gain control estimates for SU-MIMO and MU-MIMO communications, and information contained in the VHT-LTF 517 may be used to estimate various MIMO channel conditions. The VHT-SIG-B field 518 may include additional SU-MIMO and MU-MIMO information including, for example, user-specific information and the number of spatial streams associated with a given frame transmission.

In some aspects, the phase ambiguity indicator may be embedded within one of the SIG fields 514 or 518 of the preamble 510, may be embedded within staggered VHT fields 515-518 of the preamble 510, may be embedded within the VHT-LTF field 517 of the preamble 510, or may be appended to the end of the preamble 510. In other aspects, the phase ambiguity indicator may be pre-pended to preamble 510, or may be provided in a field that is inserted between a pair of the fields 512-518 of preamble 510. The phase ambiguity indicator may be embedded within the scrambler-seed of the PLCP header of a packet.

The phase ambiguity indicator may be inserted into an HT preamble in a manner similar to that described above with respect to the VHT preamble 510 of FIG. 5B (except that the phase ambiguity indicator may be inserted into the HT-SIG field of the HT preamble, not shown for simplicity).

In addition, or as an alternative, the phase ambiguity indicator may be contained in a new preamble, midamble, and/or postamble of a TGaz packet. For example, the phase ambiguity indicator may indicate whether the transmitting device is IEEE 802.11az-compliant and/or may indicate whether the transmitting device has phase ambiguity between its transmit chains.

The phase ambiguity indicator and/or phase ambiguity values may be included in a prior exchange of frames between a transmitting device and a receiving device. Although the prior exchange of frames may require the transmitting device and the receiving device to be associated with each other, association may provide a degree of trust between the transmitting device and the receiving device. More specifically, association between the transmitting device and the receiving device may increase privacy for the transmitting device, for example, because unassociated receiving devices may not be able to position transmitting devices as accurately as receiving devices that are associated with the transmitting device.

The phase ambiguity indicator and/or the phase ambiguity values may be provided from the transmitting device to the receiving device in any suitable type of frame, packet, signal, or symbol. For one example, the phase ambiguity indicator and/or the phase ambiguity values may be provided within a management frame (e.g., beacon frames, probe requests, probe responses, association requests, and so on), within a control frame (e.g., ACK frame, block ACK frame, PS-Poll frame, and so on), and/or within a data frame. The receiving device may store the phase ambiguity indicators and/or phase ambiguity values for one or more other devices in the phase ambiguity table 242 of FIG. 2.

Upon receiving a frame from a transmitting device, a receiving device may decode the address of the transmitting device, and use the decoded address to retrieve an entry from the phase ambiguity table 242 corresponding to the transmitting device (e.g., by using the decoded address as a look-up value or search key). The entry retrieved from the phase ambiguity table 242 may include an indication as to the presence of (or lack of) phase ambiguity between the transmit chains of the transmitting device, and may include one or more phase ambiguity values indicative of phase shifts between the transmit chains of the transmitting device. In some aspects, the phase ambiguity table 242 may include, for each device, an identifier (e.g., the device's MAC address, association identification (AID), IP address, and so on) and an indication as to whether the device has phase ambiguity.

In this manner, when the receiving device is to estimate AoD information for signals received from a selected device, the receiving device may determine whether there is a presence of phase ambiguity between transmit chains of the selected device by accessing the phase ambiguity table 242. If there is a lack of phase ambiguity in the selected device, then the receiving device may accurately estimate AoD information without compensating for any phase ambiguity between the transmit chains of the transmitting device. Conversely, if there is a presence of phase ambiguity in the selected device, then the receiving device may need to compensate for such phase ambiguity when estimating AoD information for signals transmitted from the selected device.

FIG. 5C shows an example preamble 520 of a HE packet within which aspects of the present disclosure may be implemented. The preamble 520 may be one implementation of the preamble 401 of the packet 400 of FIG. 4A and/or the packet 430 of FIG. 4B. The preamble 520, which may be compliant with the IEEE 802.11ax standards, is shown to include the L-STF field 512, the L-LTF field 513, and the L-SIG field 514 of preamble 510, as well as a Repeated Legacy Signal (RL-SIG) field 521, a set of HE Signal-A (HE-SIG-A1/HE-SIG-A2) fields 522, a HE Signal B (HE-SIG-B) field 523, a HE Short Training Field (HE-STF) 524, and a HE Long Training Field (HE-LTF) 525.

The RL-SIG field 521, which may be used to identify packet 520 as an HE packet, may include a time-domain waveform generated by repeating the time-domain waveform of the L-SIG field 514. The HE-SIG-A1 and HE-SIG-A2 fields 522 may include parameters such as an indicated bandwidth, a payload guard interval (GI), a coding type, a number of spatial streams (Nsts), a space-time block coding (STBC), beamforming information, and so on.

In some aspects, the HE-SIG-A1 and HE-SIG-A2 fields 955 may include a set of fields to store parameters describing the type of information stored in the HE-LTF 525 (e.g., whether the HE-LTF 525 is configured with information from which a receiving device may obtain an AoD information). For example, the set of fields includes (1) a CP+LTF Size field that stores a cyclic prefix (CP) value and a length of the HE-LTF 525; (2) an Nsts field to store information indicating the number spatial streams, (3) a STBC field store a value for space-time block coding, and (4) a transmit beamforming (TxBF) field to store information pertaining to beamforming.

The HE-SIG-B field 523 may include resource unit (RU) allocation information associated with orthogonal frequency division multiple access (OFDMA) transmissions, for example, as described in the IEEE 802.11ax specification.

Information contained in the HE-STF 524 may be used to improve automatic gain control estimates for SU-MIMO and MU-MIMO communications, and information contained in the HE-LTF 525 may be used to estimate various MIMO channel conditions. In some aspects, the HE-LTF 525 may include information (e.g., sounding sequences from which AoD information may be determined.

In some aspects, the phase ambiguity indicator may be embedded within one of the signaling fields 514 or 522 of the preamble 520, may be embedded within staggered VHT fields 515-518 of the preamble 510, or may be appended to the end of the preamble 520. In other aspects, the phase ambiguity indicator may be pre-pended to preamble 520, or may be provided in a field that is inserted between any pair of fields within the preamble 520. The phase ambiguity indicator may be embedded within the scrambler-seed of the PLCP header of a packet.

FIG. 6A shows an illustrative flow chart depicting an example operation for estimating an angle of departure of wireless signals in accordance with some aspects of the present disclosure. Although the example operation 600 is described below as being performed by a receiving device to estimate AoD information of a wireless signal transmitted from a transmitting device, it is to be understood that the example operation 600 may be performed by any suitable wireless device including, for example, the AP 110 of FIG. 1, the stations STA1-STA4 of FIG. 1, or the wireless device 200 of FIG. 2.

The receiving device may receive the wireless signal from the transmitting device (602). For example, the receiving device may receive the wireless signal using one or more of antennas 250(1)-250(n) and the transceivers 211 depicted in FIG. 2. For purposes of discussion herein, the wireless signal is transmitted from the transmitting device using two antennas. However, for other implementations, the wireless signal may be transmitted using more than two antennas of the transmitting device.

The receiving device may determine phase information of the wireless signal (604). For some implementations, the receiving device may determine phase information of the wireless signal by executing the phase information determination software module 244 of FIG. 2. In some aspects, the receiving device may receive a first component of the wireless signal from a first antenna of the transmitting device (604A), and may receive a second component of the wireless signal from a second antenna of the transmitting device (604B). Then, the receiving device may determine a phase difference between the first and second components of the wireless signal (604C). As described above with respect to FIG. 3B, the phase difference between the first and second components of the wireless signal may be indicative of the AoD of the wireless signal transmitted from the transmitting device.

The receiving device may determine a presence or absence of phase ambiguity between a number of transmit chains of the transmitting device (606). For example, the receiving device may determine the presence or absence of phase ambiguity between the transmit chains of the transmitting device by executing the phase ambiguity software module 245 of FIG. 2. For some implementations, the receiving device may obtain an indication of the presence of phase ambiguity between the transmit chains of the transmitting device. For example, FIG. 6B shows an illustrative flow chart depicting an example operation 620 for determining the presence of phase ambiguity in the transmitting device. In some aspects, the receiving device may extract, from the wireless signal, an indication of the presence of phase ambiguity between the transmit chains of the transmitting device (622). The indication may be embedded or otherwise included within any suitable portion of the wireless signal. For one example, the indication may be embedded within a preamble, midamble, or postamble of the packet. For another example, the indication may be embedded within PHY header of the packet, a MAC header of the packet, a signaling field of the packet, or a packet extension of the packet.

In other aspects, the receiving device may retrieve, from a memory of the receiving device (e.g., phase ambiguity table 242 of FIG. 2), the indication of the presence of phase ambiguity between the transmit chains of the transmitting device (624). As described above, the indication may be received by the receiving device prior to reception of the wireless signal. For one example, the indication may have been previously received in a management frame, a control frame, a data frame, or an action frame. For another example, the indication may have been previously shared with the receiving device by the transmitting device (or another device).

Alternatively, the receiving device may determine an absence of phase ambiguity between the transmit chains of the transmitting device. For example, FIG. 6C shows an illustrative flow chart depicting an example operation 630 for determining the absence of phase ambiguity in the transmitting device. In some aspects, the receiving device may extract, from the wireless signal, an indication that the transmitting device is compliant with an IEEE 802.11az specification (632), and determine the absence of phase ambiguity in the transmitting device based on the indication (634). As discussed above, because transmitting devices compliant with the IEEE 802.11az standards support next-generation (NG) packets for which there is no phase ambiguity between transmit chains, the receiving device may, upon determining that the transmitting device is compliant with the IEEE 802.11az standards, presume a lack of phase ambiguity in the transmitting device.

The receiving device may selectively adjust the phase information based on the presence or absence of phase ambiguity between the number of transmit chains of the transmitting device (608). For some implementations, the receiving device may selectively adjust the phase information by executing the angle information estimation software module 246 of FIG. 2. If there is an absence of phase ambiguity between the transmit chains of the transmitting device, then the receiving device may not adjust the phase information. Conversely, if there is a presence of phase ambiguity between the transmit chains of the transmitting device, then the receiving device may adjust the phase information. For example, FIG. 6D shows an illustrative flow chart depicting an example operation 640 for adjusting the phase information when there is a presence of phase ambiguity in the transmitting device. In some aspects, the receiving device may obtain one or more values indicating phase shifts between the number of transmit chains in the transmitting device (642), may generate a correction value based on the indicated phase shifts (644), and may apply the correction value to the determined phase information to generate the adjusted phase information (646). As discussed above, the adjusted phase information may compensate for the phase ambiguity between the transmit chains of the transmitting device.

Then, the receiving device may estimate an angle of departure of the wireless signal from the transmitting device based on the selectively adjusted phase information (610). In some aspects, the receiving device may estimate the angle of departure of the wireless signal by executing the angle information estimation software module 246 depicted in FIG. 2. In other aspects, the receiving device may estimate the angle of departure of the wireless signal using any well-known technique for estimating AoD information.

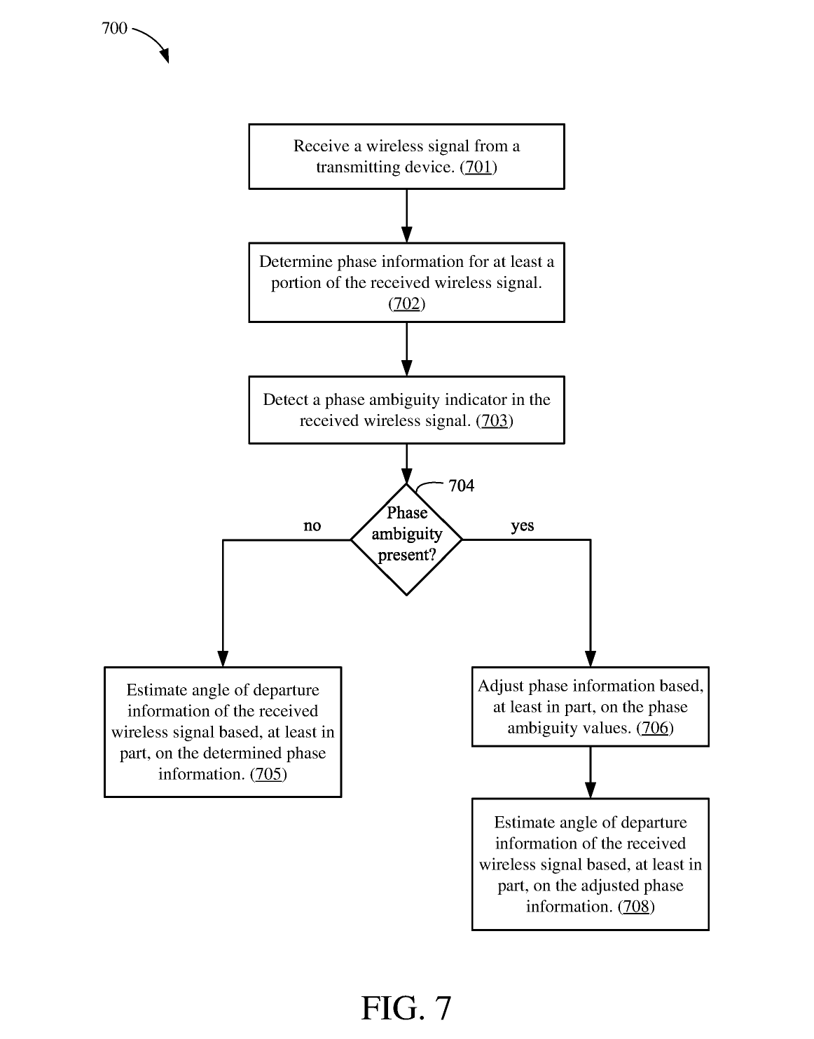

FIG. 7 is a flow chart depicting another example operation 700 for estimating an angle of departure of wireless signals in accordance with some aspects of the present disclosure. Although the example operation 700 is described below as being performed by a receiving device to estimate AoD information of a wireless signal transmitted from a transmitting device, it is to be understood that the example operation 700 may be performed by any suitable wireless device including, for example, the AP 110 of FIG. 1, the stations STA1-STA4 of FIG. 1, or the wireless device 200 of FIG. 2. In some aspects, the receiving device may be an access point, and the transmitting device may be a station associated or unassociated with the access point. In other aspects, the receiving device may be a station associated or unassociated with an access point, and the transmitting device may be the access point. In still other aspects, the receiving device and the transmitting device may communicate directly with each other.

The receiving device may receive a wireless signal from the transmitting device (701). For example, the receiving device may receive the wireless signal using one or more of antennas 250(1)-250(n) and the transceivers 211 depicted in FIG. 2. In some aspects, the wireless signal may include the phase ambiguity indicator and/or phase ambiguity values (e.g., as described above with respect to FIGS. 4A-4B and 5A-5B). In other aspects, the receiving device may determine whether the transmitting device has phase ambiguity by retrieving phase ambiguity information from the phase ambiguity table 242 of FIG. 2.

The receiving device may determine phase information for at least a portion of the received wireless signal (702). For example, the phase information may be determined by executing the angle information estimation software module 246 depicted in FIG. 2. The receiving device may detect that the phase ambiguity indicator is embedded within the received wireless signal (703), and may then decode the phase ambiguity indicator to determine whether there is a presence of phase ambiguity in the transmitting device (704). For example, the receiving device may detect and decode the phase ambiguity indicator by executing phase ambiguity indicator software module 245 of FIG. 2.

If there is not a presence of phase ambiguity in the transmitting device, as tested at 704, then the receiving device may estimate angle of departure information of the received wireless signal based, at least in part, on the determined phase information (705). For example, the receiving device may estimate the angle of departure information by executing the angle information estimation software module 246 of FIG. 2.

Conversely, if there is a presence of phase ambiguity in the transmitting device, as tested at 704, then the receiving device may adjust the determined phase information based, at least in part, on the phase ambiguity values indicated by the transmitting device (706). For example, the determined phase information may be adjusted by executing the angle information estimation software module 246 of FIG. 2. Then, the receiving device may estimate angle of departure information of the received wireless signal based, at least in part, on the adjusted phase information (708). For example, the receiving device may estimate the angle of departure information by executing the angle information estimation software module 246 of FIG. 2. Alternately, upon determining that there is a presence of phase ambiguity between transmit chains of the second wireless, as tested at 704, the receiving device may ignore the packet for purposes of determining AoD information.

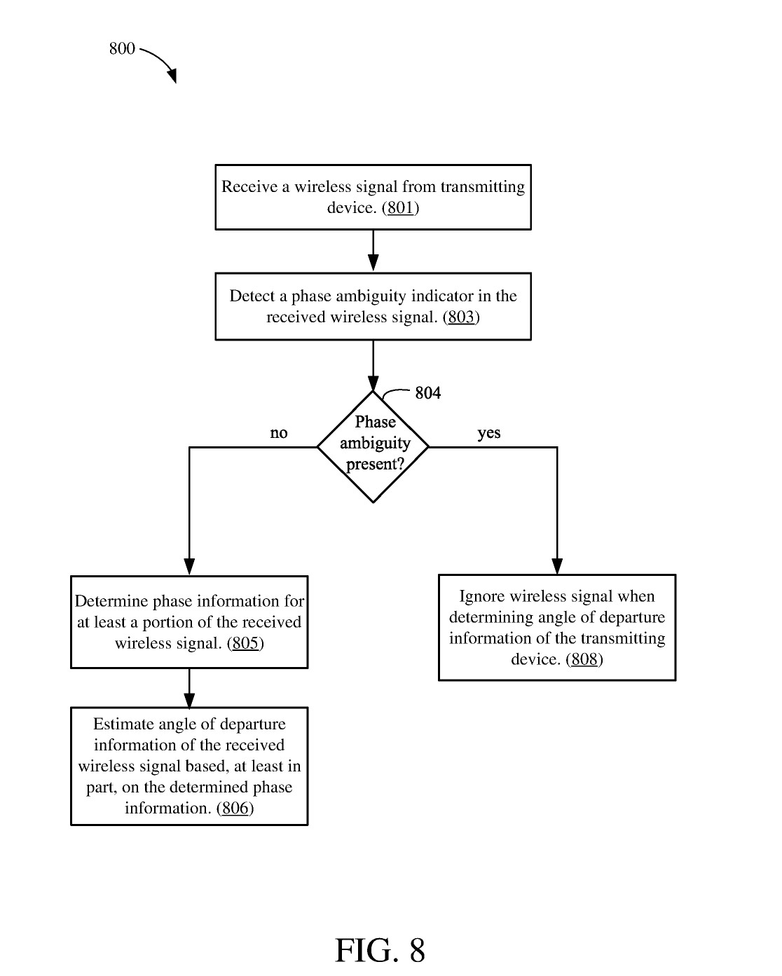

FIG. 8 is a flow chart depicting another example operation 800 for estimating an angle of departure of wireless signals in accordance with some aspects of the present disclosure. Although the example operation 800 is described below as being performed by a receiving device to estimate AoD information of a wireless signal transmitted from a transmitting device, it is to be understood that the example operation 800 may be performed by any suitable wireless device including, for example, the AP 110 of FIG. 1, the stations STA1-STA4 of FIG. 1, or the wireless device 200 of FIG. 2. In some aspects, the receiving device may be an access point, and the transmitting device may be a station associated or unassociated with the access point. In other aspects, the receiving device may be a station associated or unassociated with an access point, and the transmitting device may be the access point. In still other aspects, the receiving device and the transmitting device may communicate directly with each other.

The receiving device may receive a wireless signal from the transmitting device (801). For example, the receiving device may receive the wireless signal using one or more of antennas 250(1)-250(n) and the transceivers 211 depicted in FIG. 2. In some aspects, the wireless signal may include the phase ambiguity indicator and/or phase ambiguity values (e.g., as described above with respect to FIGS. 4A-4B and 5A-5C). In other aspects, the receiving device may determine whether there is a presence of phase ambiguity in the transmitting device by retrieving a corresponding entry from the phase ambiguity table 242 of FIG. 2.

The receiving device may detect that the phase ambiguity indicator is embedded within the received wireless signal (803), and may then decode the phase ambiguity indicator to determine whether there is a presence of phase ambiguity between the transmit chains of the transmitting device (804). For example, the receiving device may detect and decode the phase ambiguity indicator by executing phase ambiguity software module 245 of FIG. 2.

If there is not a presence of phase ambiguity in the transmitting device, as tested at 804, then the receiving device may determine phase information for at least a portion of the received wireless signal (805). For example, the phase information may be determined by executing the angle information estimation software module 246 of FIG. 2. Then, the receiving device may estimate angle of departure information of the received wireless signal based, at least in part, on the determined phase information (806). For example, the receiving device may estimate the angle of departure information by executing the angle information estimation software module 246 of FIG. 2.

Conversely, if there is a presence of phase ambiguity in the transmitting device, as tested at 804, then the receiving device may ignore the wireless signal when determining angle of departure information of the transmitting device (808).

For other implementations, the transmitting device may intentionally introduce a phase ambiguity in its transmit chains or may intentionally set its phase ambiguity indicator in the packet (e.g., to indicate the presence of phase ambiguity) if it does not want its AoD information to be determined, for example, for privacy reasons. As an example the user interface of a cellular phone or tablet may expose a setting to the user allowing him to enter/exit privacy mode the effect of such privacy mode being introducing a random phase ambiguity.

In some cases, rather than actually transmitting a frame a device may have an interface to output a frame for transmission. For example, a processor may output a frame, via a bus interface, to a radio frequency (RF) front end for transmission. Similarly, rather than actually receiving a frame, a device may have an interface to obtain a frame received from another device. For example, a processor may obtain (or receive) a frame, via a bus interface, from an RF front end for reception.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, in some aspects, a means for receiving a wireless signal from a transmitting device may correspond to a transceiver (e.g., transceivers 211 of FIG. 2). A means for determining phase information of the wireless signal may correspond to a processor (e.g., execution of the phase ambiguity software module 245 by the processor 230 of FIG. 2). A means for determining a presence of phase ambiguity may correspond to a processor (e.g., execution of the phase ambiguity software module 245 by the processor 230 of FIG. 2) or to a memory (e.g., the phase ambiguity table 242 of FIG. 2). A means for adjusting the phase information may correspond to a processor (e.g., execution of the phase ambiguity software module 245 by the processor 230 of FIG. 2). A means for estimating an angle of departure of the wireless signal may correspond to a processor (e.g., execution of the angle information estimation software module 246 by the processor 230 of FIG. 2).

According to certain aspects, such means may be implemented by processing systems configured to perform the corresponding functions by implementing various algorithms (e.g., in hardware or by executing software instructions) described above for generating frames for transmission during a sector sweep procedure.

As used herein, the term “generating” encompasses a wide variety of actions. For example, “generating” may include calculating, causing, computing, creating, determining, processing, deriving, investigating, making, producing, providing, giving rise to, leading to, resulting in, looking up (e.g., looking up in a table, a database or another data structure), ascertaining and the like. Also, “generating” may include receiving (e.g., receiving information), accessing (e.g., accessing data in a memory) and the like. Also, “generating” may include resolving, selecting, choosing, establishing and the like.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Also, “determining” may include measuring, estimating and the like.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a station (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-Ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method comprising:
receiving a wireless signal from a transmitting device;
determining phase information of the wireless signal;
determining a presence or absence of phase ambiguity between a number of transmit chains of the transmitting device;
selectively adjusting the phase information based on the presence or absence of phase ambiguity between the number of transmit chains of the transmitting device; and
estimating an angle of departure of the wireless signal from the transmitting device based on the selectively adjusted phase information.

2. The method of claim 1, wherein determining the absence of phase ambiguity comprises:
extracting, from the wireless signal, an indication that the transmitting device is compliant with an IEEE 802.11az specification; and
determining the absence of phase ambiguity between the number of transmit chains of the transmitting device based on the indication.

3. The method of claim 2, wherein the phase information is not adjusted based on the determined absence of phase ambiguity between the number of transmit chains.

4. The method of claim 1, wherein determining the presence of phase ambiguity comprises:
extracting, from the wireless signal, an indication of the presence of phase ambiguity between the number of transmit chains of the transmitting device.

5. The method of claim 4, wherein the wireless signal comprises a packet, and the indication is embedded within at least one of a preamble of the packet, a physical-layer (PHY) header of the packet, a medium access control (MAC) header of the packet, a signaling field of the packet, or a packet extension of the packet.

6. The method of claim 1, wherein determining the presence of phase ambiguity comprises:
retrieving, from a memory, an indication of the presence of phase ambiguity between the number of transmit chains of the transmitting device.

7. The method of claim 6, further comprising:
receiving the indication from at least one of a management frame, a control frame, a data frame, or an action frame prior to reception of the wireless signal; and
storing the indication in the memory.

8. The method of claim 1, wherein adjusting the phase information comprises:
obtaining one or more values indicating phase shifts between the number of transmit chains in the transmitting device;
generating a correction value based on the indicated phase shifts; and
applying the correction value to the determined phase information.

9. The method of claim 8, wherein the obtaining comprises:
extracting the one or more values from the wireless signal.

10. The method of claim 9, wherein the wireless signal comprises a packet, and the one or more values are embedded within at least one of a preamble of the packet, a physical-layer (PHY) header of the packet, a medium access control (MAC) header of the packet, a signaling field of the packet, or a packet extension of the packet.

11. The method of claim 8, wherein the obtaining comprises:
receiving the one or more values from at least one of a management frame, a control frame, a data frame, or an action frame prior to reception of the wireless signal.

12. A receiving device, comprising:
one or more processors; and
a memory configured to store instructions that, when executed by the one or more processors, cause the receiving device to:
receive a wireless signal from a transmitting device;
determine phase information of the wireless signal;
determine a presence or absence of phase ambiguity between a number of transmit chains of the transmitting device;
selectively adjust the phase information based on the presence or absence of phase ambiguity between the number of transmit chains of the transmitting device; and
estimate an angle of departure of the wireless signal from the transmitting device based on the selectively adjusted phase information.

13. The receiving device of claim 12, wherein execution of the instructions to determine the absence of phase ambiguity causes the receiving device to:
extract, from the wireless signal, an indication that the transmitting device is compliant with an IEEE 802.11az specification; and
determine the absence of phase ambiguity between the number of transmit chains of the transmitting device based on the indication.

14. The receiving device of claim 13, wherein the phase information is not adjusted based on the determined absence of phase ambiguity between the number of transmit chains.

15. The receiving device of claim 12, wherein execution of the instructions to determine the presence of phase ambiguity causes the receiving device to:
extract, from the wireless signal, an indication of the presence of phase ambiguity between the number of transmit chains of the transmitting device.

16. The receiving device of claim 15, wherein the wireless signal comprises a packet, and the indication is embedded within at least one of a preamble of the packet, a physical-layer (PHY) header of the packet, a medium access control (MAC) header of the packet, a signaling field of the packet, or a packet extension of the packet.

17. The receiving device of claim 12, wherein execution of the instructions to determine the presence of phase ambiguity causes the receiving device to:
retrieve, from the memory, an indication of the presence of phase ambiguity between the number of transmit chains of the transmitting device.

18. The receiving device of claim 12, wherein execution of the instructions to determine the presence of phase ambiguity causes the receiving device to:
receive an indication from at least one of a management frame, a control frame, a data frame, or an action frame prior to reception of the wireless signal; and
store the indication in the memory.

19. The receiving device of claim 12, wherein execution of the instructions to adjust the phase information causes the receiving device to:
obtain one or more values indicating phase shifts between the number of transmit chains in the transmitting device;
generate a correction value based on the indicated phase shifts; and
apply the correction value to the determined phase information.

20. The receiving device of claim 19, wherein execution of the instructions to obtain the one or more values causes the receiving device to:
extract the one or more values from the wireless signal.

21. The receiving device of claim 20, wherein the wireless signal comprises a packet, and the one or more values are embedded within at least one of a preamble of the packet, a physical-layer (PHY) header of the packet, a medium access control (MAC) header of the packet, a signaling field of the packet, or a packet extension of the packet.

22. The receiving device of claim 19, wherein execution of the instructions to obtain the one or more values causes the receiving device to:
receive the one or more values from at least one of a management frame, a control frame, a data frame, or an action frame prior to reception of the wireless signal.

23. A non-transitory computer-readable medium comprising instructions that, when executed by one or more processors of a receiving device, cause the receiving device to perform operations comprising:
receiving a wireless signal from a transmitting device;
determining phase information of the wireless signal;
determining a presence or absence of phase ambiguity between a number of transmit chains of the transmitting device;
selectively adjusting the phase information based on the presence or absence of phase ambiguity between the number of transmit chains of the transmitting device; and
estimating an angle of departure of the wireless signal from the transmitting device based on the selectively adjusted phase information.

24. The non-transitory computer-readable medium of claim 23, wherein execution of the instructions to determine the absence of phase ambiguity causes the receiving device to perform operations further comprising:
extracting, from the wireless signal, an indication that the transmitting device is compliant with an IEEE 802.11az specification; and
determining the absence of phase ambiguity between the number of transmit chains of the transmitting device based on the indication.

25. The non-transitory computer-readable medium of claim 24, wherein the phase information is not adjusted based on the determined absence of phase ambiguity between the number of transmit chains.

26. The non-transitory computer-readable medium of claim 23, wherein execution of the instructions to determine the presence of phase ambiguity causes the receiving device to perform operations further comprising:
extracting, from the wireless signal, an indication of the presence of phase ambiguity between the number of transmit chains of the transmitting device.

27. The non-transitory computer-readable medium of claim 23, wherein execution of the instructions to adjust the phase information causes the receiving device to perform operations further comprising:
obtaining one or more values indicating phase shifts between the number of transmit chains in the transmitting device;
generating a correction value based on the indicated phase shifts; and
applying the correction value to the determined phase information.

28. A receiving device, comprising:
means for receiving a wireless signal from a transmitting device;
means for determining phase information of the wireless signal;
means for determining a presence or absence of phase ambiguity between a number of transmit chains of the transmitting device;
means for selectively adjusting the phase information based on the presence or absence of phase ambiguity between the number of transmit chains of the transmitting device; and
means for estimating an angle of departure of the wireless signal from the transmitting device based on the selectively adjusted phase information.

29. The receiving device of claim 28, wherein the means for determining the absence of phase ambiguity is to:
extract, from the wireless signal, an indication that the transmitting device is compliant with an IEEE 802.11az specification; and
determine the absence of phase ambiguity between the number of transmit chains of the transmitting device based on the indication.

30. The receiving device of claim 28, wherein the means for determining the presence of phase ambiguity is to:
extract, from the wireless signal, an indication of the presence of phase ambiguity between the number of transmit chains of the transmitting device.
